(19) United States
(12) Patent Application Publication
(10) Pub. No.: US 2009/0010453 A1
(43) Pub. Date: Jan. 8, 2009

(54) INTELLIGENT GRADIENT NOISE REDUCTION SYSTEM

(75) Inventors: ROBERT A. ZUREK, ANTIOCH, IL (US); JOEL A. CLARK, WOODRIDGE, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/772,670

(22) Filed: Jul. 2, 2007

(51) Int. Cl. H04B 15/00

(52) U.S. Cl. 381/94.5; 381/94.1; 381/94.7

(57) ABSTRACT

An intelligent noise reduction system (100) is provided. The system can include a gradient microphone (110) to produce a gradient speech signal, a correction unit (116) to de-emphasize a high frequency gain imparted by the gradient microphone, a Voice Activity Detector 120 (VAD) to determine portions of speech activity (701) and portions of noise activity (702) in the gradient speech signal, an Automatic Gain Control 130 (AGC) unit to adapt a speech gain (740) of the gradient speech signal to minimize variations in speech signal levels, and a controller (140) to control the speech gain applied by the AGC to the portions of noise activity to preserve a speech to noise level ratio between speech activity and noise activity in the gradient speech signal.

### FIELD OF THE INVENTION

The present invention relates to noise suppression and, more particularly, to an intelligent gradient noise reduction system.

### BACKGROUND

Mobile devices providing voice communications generally include a noise reduction system to suppress unwanted noise. The unwanted noise may be environmental noise, such as background noise, that is present when a user is speaking into the mobile device. A microphone that captures a voice signal from the user may capture the unwanted background noise and produce a composite signal containing both the voice signal and the unwanted background noise. The unwanted background noise can degrade a quality of the voice signal if the unwanted noise is not adequately suppressed.

An omni-directional microphone can capture voice from all directions. Referring to FIG. 9, an exemplary sensitivity pattern 900 of an omni-directional microphone is shown. The front port of the microphone where sound is captured corresponds to the 90 degree mark, at the top. The sensitivity pattern 901 reveals that the omni-directional microphone can capture sound from all directions equally (e.g. 0 to 360 degrees). Accordingly, the omni-directional microphone can capture sound, such as noise, from directions other than the principal direction of the sound, such as voice, which generally arrives at the front port of the omni-directional microphone. Consequently, when a user is speaking in the front port, the omni-directional microphone picks up the voice signal and also any other peripheral sounds, such as background noise, equally, thus not providing any noise suppression capabilities.

In contrast, a gradient microphone can capture voice arriving from a principal direction. Referring to FIG. 10, an exemplary sensitivity pattern 950 of a gradient microphone is shown. The front port of the gradient microphone where sound is captured also corresponds to the 90 degree mark, at the top. The sensitivity pattern 950 reveals that the gradient microphone is more sensitive to sound arriving at a front 951 and back 952 portion (e.g. 90 and 270 degrees) of the gradient microphone, than from the left and right sides (e.g. 180 and 0 degrees) of the gradient microphone. The sensitivity pattern 950 shows regions of null sensitivity at the left and right locations. Sound arriving at the left and right will be suppressed more than sounds arriving from the front and back. Accordingly, the gradient microphone provides an inherent noise suppression on sounds arriving at directions other than the principal direction (e.g. front or back). Consequently, when a user is speaking in the front port while ambient noise is present in all directions, the gradient microphone captures the voice signal though suppresses the noise peripheral (e.g. left and right) to the principal front direction.

### SUMMARY

The gradient microphone is more sensitive to variations in distance than the omni-directional microphone. For example, as the user moves farther away from the front port, the sensitivity decreases more than an omni-directional microphone as a function of the distance between the user and the microphone. As the user moves closer to the front port, the sensitivity increases as a function of the distance of the user. Accordingly, noise reduction systems that use a gradient microphone as the means to capture a voice signal exhibit large changes in amplitude for small changes in position when the user is close to the microphone. Moreover, the gradient microphone is sensitive to variations in movement of the mobile device housing the gradient microphone, for example, when the user handles the mobile device while speaking. In such regard, it is desirable to provide a noise reduction system that achieves noise reduction capabilities of a gradient microphone but without sound level variance caused by movement of the mobile device due to the proximity effect of the gradient microphone.

One embodiment of the present disclosure is an intelligent noise reduction system that can include a microphone unit to capture a speech signal, a Voice Activity Detector (VAD) operatively coupled to the microphone unit to determine portions of speech activity and portions of noise activity in the speech signal, an Automatic Gain Control (AGC) unit operatively coupled to the microphone unit for adapting a speech gain of the speech signal to minimize variations in speech signal levels, and a controller operatively coupled to the VAD and the AGC to control the speech gain applied by the AGC to the portions of noise activity to smooth audible transitions between speech activity and noise activity. In a first exemplary configuration, the controller can prevent an update of the speech gain during portions of noise activity. The controller can resume adaptation of the speech gain following the portions of noise activity. In a second exemplary configuration the controller can apply a noise gate during portions of noise activity. In a third exemplary configuration, the controller can apply a smooth gain transition between a last speech frame gain and a gated noise frame during portions of noise in the gradient speech. The smooth gain transition can be linear, logarithmic, or quadratic decay.

In one arrangement, the microphone unit can be a gradient microphone that operates on a difference in sound pressure level between a front portion and back portion of the gradient microphone to produce a gradient speech signal. A sensitivity of the gradient microphone can change as a function of a distance to a source producing the speech signal. In another arrangement, the microphone unit can include a first microphone, a second microphone, and a differencing unit that subtracts a first signal received by the first microphone from a second signal received by a second microphone to produce a gradient speech signal. The intelligent noise reduction system can include a correction filter that applies a high frequency attenuation to the gradient speech signal to correct for high frequency gain due to the gradient process.

A second embodiment of the present disclosure is a method for intelligent noise reduction that can include capturing a speech signal, identifying portions of speech activity and portions of noise activity in the speech signal, adapting a speech gain of the speech signal to minimize variations in speech signal levels during portions of speech activity, and controlling the speech gain in portions of noise activity to smooth audible transitions between speech activity and noise activity. The step of controlling the speech gain can includes preventing an adaptation of the speech gain during portions of noise activity, and resuming adaptation of the speech gain following portions of noise activity. The step of controlling the speech gain can include freezing the speech gain during portions of noise activity, applying a noise gate during portions of noise activity, or applying a smooth gain transition between a last speech frame gain and a gated noise frame during portions of noise in the gradient speech. The method can include capturing a first signal from a first microphone, capturing a second signal from a second microphone, subtracting the first signal and the second signal to produce a gradient speech signal, and applying a correction filter to compensate for frequency dependant amplitude loss due to the subtracting.

A third embodiment of the present disclosure is an intelligent noise reduction system that can include a gradient microphone to produce a gradient speech signal, a correction unit to de-emphasize a high frequency gain of the gradient speech signal due to the gradient microphone, a Voice Activity Detector (VAD) operatively coupled to the correction unit to determine portions of speech activity and portions of noise activity in the gradient speech signal, an Automatic Gain Control (AGC) unit operatively coupled to the gradient microphone to adapt a speech gain of the gradient speech signal to minimize variations in speech signal levels, and a controller operatively coupled to the VAD and the AGC to control the speech gain applied by the AGC to the portions of noise activity to preserve a speech to noise level ratio between speech activity and noise activity in the gradient speech signal. The controller can freeze the speech gain during portions of noise activity, apply a noise gate during portions of noise activity, or apply a smooth gain transition between a last speech frame gain and a gated noise frame during portions of noise in the gradient speech. The controller can prevent an adaptation of the speech gain during portions of noise activity, and resume the adaptation of the speech gain following portions of noise activity.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 depicts an exemplary intelligent noise reduction system in accordance with an embodiment of the present disclosure;

FIG. 2 depicts an exemplary microphone unit in accordance with an embodiment of the present disclosure;

FIG. 3 depicts an exemplary method for intelligent noise reduction in accordance with an embodiment of the present disclosure;

FIG. 4 depicts an extension of the method of FIG. 3 for controlling an Automatic Gain Control (AGC) in accordance with an embodiment of the present disclosure;

FIG. 5 depicts a 100 Hz sensitivity versus distance plot normalized to an omni-directional response for an omni-directional and gradient microphone in accordance with an embodiment of the present disclosure;

FIG. 6 depicts a 300 Hz sensitivity versus distance plot normalized to an omni-directional response for an omni-directional and gradient microphone in accordance with an embodiment of the present disclosure;

FIG. 7 depicts an exemplary plot for intelligent noise reduction in accordance with an embodiment of the present invention;

FIG. 8 is a block diagram of an electronic device in accordance with an embodiment of the present invention;

FIG. 9 depicts a polar sensitivity or directivity plot of an omni-directional microphone; and

FIG. 10 depicts a polar sensitivity or directivity plot of an gradient microphone.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” or “processor” can be defined as any number of suitable processors, controllers, units, or the like that are capable of carrying out a pre-programmed or programmed set of instructions. The terms “program,” “software application,” and the like as used herein, are defined as a sequence of instructions designed for execution on a computer system. A program, computer program, or software application may include a subroutine, a function, a procedure, an object method, an object implementation, an executable application, a source code, an object code, a shared library/dynamic load library and/or other sequence of instructions designed for execution on a computer system.

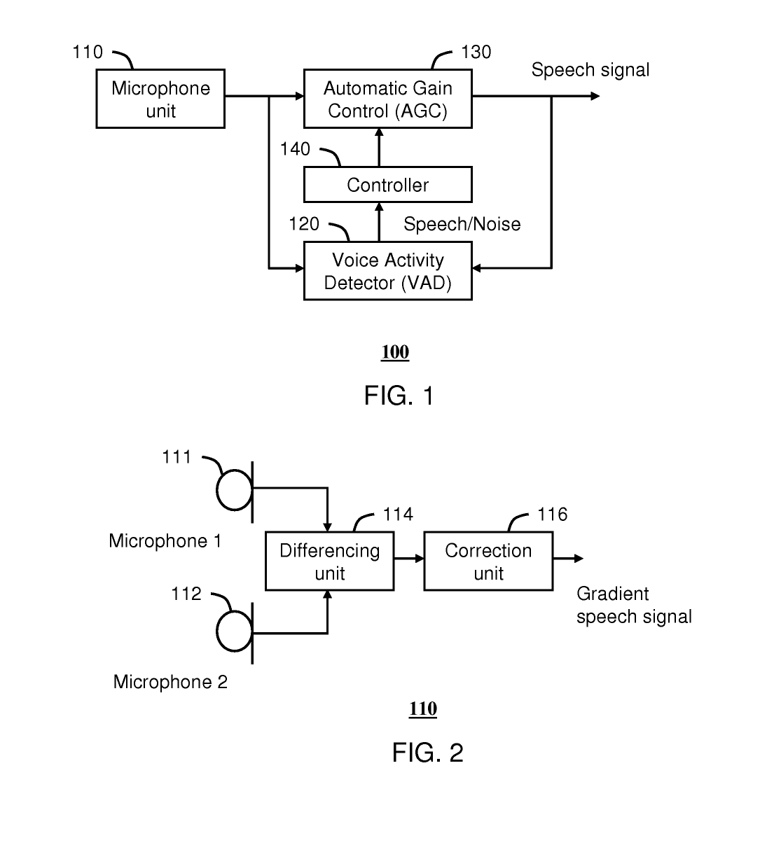

Referring to FIG. 1, an intelligent noise reduction system 100 is shown. The intelligent noise reduction system 100 can include a microphone unit 110, a Voice Activity Detector 120 (VAD) operatively coupled to the microphone unit 110, an Automatic Gain Control 130 (AGC) unit operatively coupled to the microphone unit 110, and a controller 140 operatively coupled to the VAD 120 and the AGC 130. The VAD 120 can receive feedback from the speech signal output of the AGC 130. The intelligent noise reduction system 100 can be integrated within a mobile device, such as a cell phone, laptop, computer, or any other mobile communication device. Broadly stated, the VAD 120 detects the presence of speech and noise, and the controller 140 responsive to receiving the voice activity decisions from the VAD 120 controls the AGC 130 during regions of noisy activity. The intelligent noise reduction system 100 can suppress unwanted noise in a sound signal captured by the microphone unit 110 during periods of noise activity.

In one arrangement in accordance with an embodiment of the invention, the microphone unit 110 can be a gradient microphone. The gradient microphone operates on a difference in sound pressure level between two points of a sound signal, and not the sound pressure level at a point on the sound signal. Consequently, the gradient microphone is more sensitive to variations in distance from a source producing the sound signal. For example, when a user is in close proximity to the microphone unit 110 the gradient microphone detects a large difference in the Sound Pressure Level (SPL) of an acoustic waveform captured at a front portion of the gradient microphone and the same acoustic waveform captured at back portion of the gradient microphone. When the user is farther away from the microphone the gradient microphone detects a small difference in the Sound Pressure Level (SPL) of an acoustic waveform captured at the front portion of the gradient microphone and the same acoustic waveform captured at the back portion of the gradient microphone.

In another arrangement, in accordance with an embodiment of the invention, the gradient microphone can be realized as two microphones that together form a gradient process. Referring to FIG. 2, an exemplary configuration of the microphone unit 110 is shown. The microphone unit 110 can include a first microphone 111, a second microphone 112, and a differencing unit 114 that subtracts a first signal received by the first microphone from a second signal received by a second microphone to produce a gradient speech signal. The gradient microphone is created by subtracting the microphone signals and then running the resultant single signal through a correction filter. The correction filter applies (e.g. de-emphasizes) a high frequency attenuation to the gradient speech signal to compensate for high frequency gain as a result of the gradient process.

The microphone unit 110 of FIG. 2 operates similarly in principle to the gradient microphone, though it uses two separate microphones to achieve the front and back effect. The gradient process operates on a difference in sound pressure level between the first microphone 111 and the second microphone 112 to produce a gradient speech signal. The gradient process realized by the microphone unit 110 of FIG. 2 includes differencing and correction which consequently attenuates a sound signal more as the distance to the source increases. This increase in attenuation due to far-field effects generates a variation in signal level due to movement of the microphones relative to the person speaking. The gradient process also introduces an amplification when a sound signal is captured in close proximity (e.g. near-field) to the microphone unit 110. The controller 140 compensates for these near-field and far-field effects by directing the AGC 130 to adjust the speech gain applied to portions of the signal captured at the microphone during periods of speech activity.

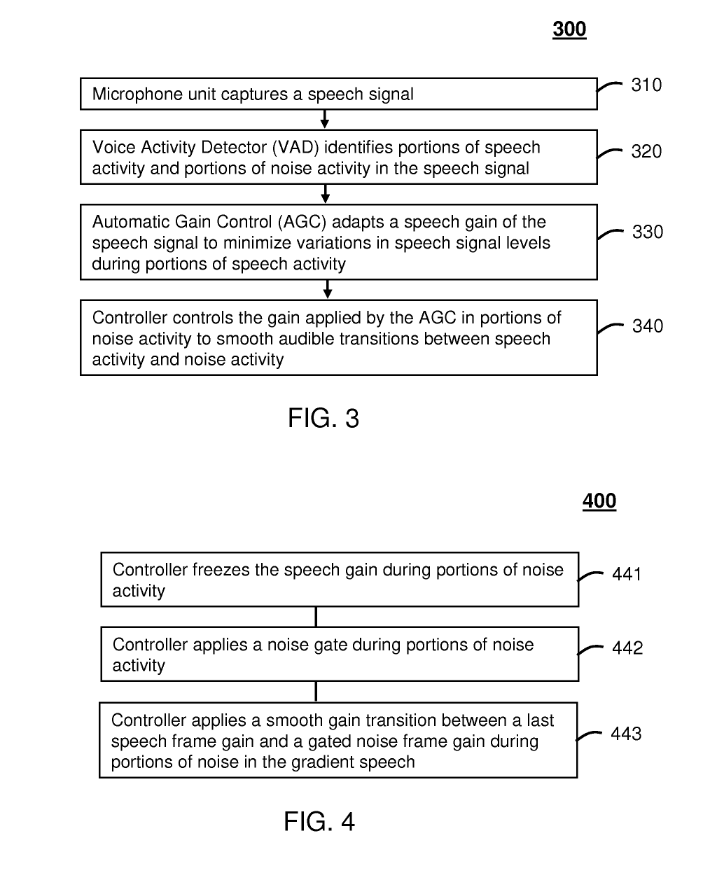

Referring to FIGS. 3 and 4, a method for 300 intelligent noise reduction is shown. The method 300 can be practiced with more or less than the number of components shown. Reference will also be made to FIGS. 1, 2, 5, 6 and 7 when describing the method 300. Briefly, the method 300 can be practiced by the intelligent noise reduction system 100 of FIG. 1. As an example, the method 300 can start in a state in which the intelligent noise reduction system 100 is used in a mobile device to suppress unwanted noise.

At step 310, the microphone unit 110 captures a speech signal. As an example, a user holding the mobile device can orient a directionality of the microphone unit 110 towards the user. The user can hold the mobile device at varying distances, for example, in a near-field (i.e. close proximity) to the user or in a far-field (i.e. farther away) to the user. Background noise, such as other people speaking, or environmental noise may be present in the speech signal captured by the microphone unit 110.

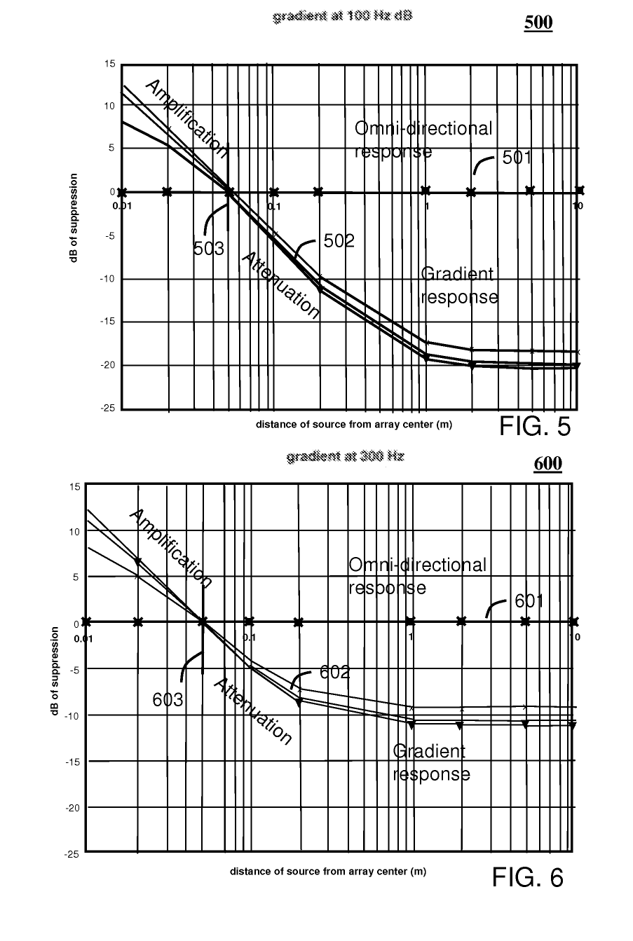

FIG. 5 shows a sensitivity versus distance plot 500 for the speech signal at 100 Hz using either an omni-directional microphone or a gradient microphone. The plot 500 illustrates the difference in sensitivity between the omni-directional microphone and the gradient microphone, for example, when the mobile device is held at different arm lengths. The plot 500 is normalized to a 5 cm distance which is equivalent to a typical mobile device microphone position. That is, the decibel reference is the sensitivity of approximately 5 cm away from the microphone. The normalization allows one to directly visualize differences in amplitude gain for the gradient microphone compared to the omni-directional microphone. As illustrated, the omni-directional response differential 501 is 0 dB, since there is no difference between the omni-directional response and itself. Accordingly, the gradient responses 502 are relative to the unity normalized omni-directional response 501. In such regard, one can see that the gradient microphone introduces an amplification of 100 Hz signals in the near-field below the cross over point 503, and introduces an attenuation of 100 Hz signals in the far-field beyond the cross over point 503. As shown, the cross over point 503 occurs at approximately 5 cm. The attenuation approaches −20 dB at 1 m and beyond, and the amplification approaches +10 dB below a 5 cm distance from the microphone.

FIG. 6 shows a sensitivity versus distance plot 600 for the speech signal at 300 Hz dB using either an omni-directional microphone or a gradient microphone. The plot 600 also illustrates the difference in sensitivity between the omni-directional microphone and the gradient microphone, for example, when the mobile device is held at different arm lengths. The primary difference between FIG. 5 and FIG. 6 is the frequency of the signal being captured at the microphone. In FIG. 5, the gradient responses 502 correspond to a captured microphone signal frequency of 100 Hz, and in FIG. 6 the gradient responses correspond to a captured microphone signal frequency of 300 Hz. As shown in FIG. 6, the gradient process introduces an attenuation that approaches −10 dB at 1 m and beyond (in contrast to the −20 dB attenuation at 100 Hz), though the amplification still approaches +10 dB below the 5 cm cross over point 603. The amount of maximum attenuation lessens as the frequency increases, for example, up to 20 KHz.

Briefly, the response plots 500 and 600 illustrate the pronounced amplification of the gradient process within the near-field, and the pronounced attenuation of the gradient process in the far-field. Notably, the amplification due to the gradient process increases the sensitivity of the mobile device within the near-field and can introduce significant changes in amplitude with small variations in distance. For instance, the speech can be amplified in disproportionate amounts if the user moves the mobile device significantly during talking.

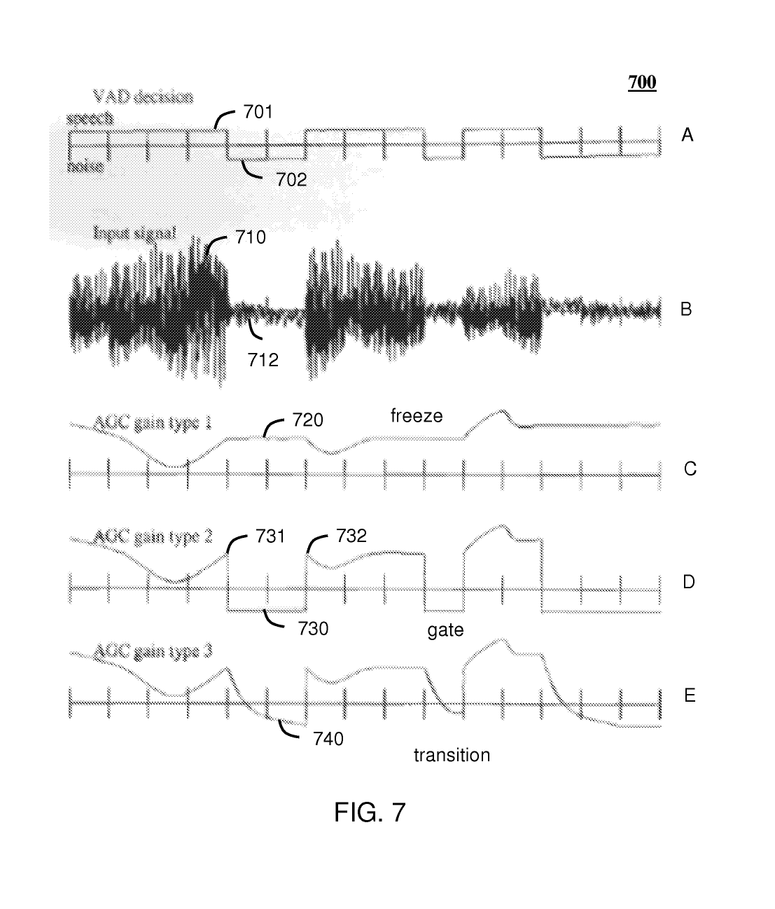

Returning back to FIG. 3, at step 320, the VAD 120 identifies portions of speech activity and portions of noise activity (non-speech) in the speech signal. Consider that the signal captured at the microphone unit 110 includes portions of both speech and noise. For example, the voice of the user speaking into the phone constitutes speech, and any background noise captured by the microphone unit 100 constitutes noise. FIG. 7 presents a group of exemplary subplots for visualizing the intelligent noise reduction method 300. Subplot A shows the VAD 120 decisions for portions of speech activity 701 and noise activity 702. More specifically, subplot A shows frames of the signal captured by the microphone unit 110. The length of the frame size can be between 5 ms to 20 ms but is not limited to these values. The signals can be sampled at various fixed or mixed sampling rates (e.g. 8 KHz, 16 Khz) under various quantization schemes (e.g. 16 bit, 32 bit). The VAD 120 makes a speech classification 701 or noise classification 702 decision for each frame processed. Subplot B shows the speech signal captured by the microphone unit 110 corresponding to the VAD decisions of subplot A. Notably, the speech portions 710 coincide with speech classification 701 decisions, and the noise portions 712 coincide with the noise classification decisions 702.

Returning back to FIG. 3, at step 330, the AGC 130 adapts a speech gain of the speech signal to minimize variations in speech signal levels during portions of speech activity. The AGC 130 internally estimates a gain that is applied to the speech signal to compensate for variations in signal amplitude. However, the AGC, which is tuned for use with an omni-directional microphone, can not adequately set the gain to account for variations due to the gradient process. Accordingly, at step 340, the controller 140 controls the adaptation of the speech gain applied by the AGC 130 based on the speech and noise designations received from the VAD 120. Referring back to FIG. 7, the controller smoothes audible transitions between speech activity and noise activity.

Notably, the controller 140 does not interfere with the AGC speech gain adjustments applied to the speech signal during periods of speech activity 710. During speech activity, the controller 140 does not disrupt the normal processes of the AGC, and only monitors the classification decisions by the VAD 120. The controller 140 does engage with the AGC 130 to adjust the gain adjustments of the AGC 130 when the VAD 120 classifies portions of the speech signal as regions of noise activity 712. In such regard, the controller 140 then engages with the AGC 130 to cause the AGC 130 to adjust the gain applied to the speech signal during periods of noisy activity 712. In particular, the controller 140 prevents the AGC 130 from adapting during noise frames and preserves the AGC speech gain at the end of the last speech frame to be used as a starting point for the AGC when a new speech frame occurs.

Referring to FIG. 4, various methods 400 implemented by the controller 140 to control the AGC 130 are shown. Reference will be made to FIG. 7 when describing the various methods 400.

As shown in method 441, the controller freezes the speech gain during portions of noise activity. More specifically, the controller prevents an update of the speech gain within the AGC 130 during portions of noise activity, and allows the AGC to resume adaptation of the speech gain following the portions of noise activity. Referring to subplot C of FIG. 7, an exemplary speech gain plot of the AGC 130 is shown. It should be noted that the AGC 130 determines the speech gain based on various aspects of the speech signal, such as the peak-to-peak voltage, the root mean square (RMS) value, distribution of spectral energy, and/or temporal based measures. In particular, the AGC 130 attempts to balance the distribution of spectral energy in the captured speech signal based on one or more voice metrics. Returning back to step 441, the controller freezes the speech gain at the onset of the VAD detecting noise activity, and holds the speech gain constant 720 during the region of noise activity. The controller 130 removes the freeze on the signal gain responsive VAD detecting the onset of speech activity. This allows the AGC 130 to continue adaptation as though the speech signal consisted entirely of speech.

Notably, the controller 140 freezes the speech gain for preventing the AGC 130 from amplifying the noise activity level, and also to allow the AGC to resume adaptation as though the AGC were processing continuous speech. In the former, the user at a receiving end of the voice communication link will hear a smooth transition between speech activity and noise activity. Moreover, a ratio of the noise level to speech level will be constant and representative of the noise to speech level captured by the microphone unit 110. In the latter, the AGC 130 does not need to re-adjust internal metrics to compensate for signal gain adjustments due to noise activity. That is, the controller 140 allows the AGC to remain in a speech processing mode.

Returning back to FIG. 4, as shown in method 442, the controller 140 can alternatively apply a noise gate during portions of noise activity. More specifically, the controller 140 establishes a noise floor for periods of noise activity. In practice, when the VAD 120 detects noise activity, the controller 140 directs the AGC 130 to suppress the signal to a predetermined noise floor level. For example, the AGC generates comfort noise during periods of noise activity responsive to a direction by the controller 140 to apply a noise gate. In addition a low level artificial “comfort noise” may be added to the signal during gated noise frames to lessen the negative perceptual impact of the gating process.

Subplot D of FIG. 7 visually illustrates the results of applying a noise gate to portions of noise activity. As shown, the controller 140 applies the noise gate 730 during periods of noise activity responsive to receiving a noise classification decision by the VAD 120. The controller 140 can store the last speech gain 731 applied by the AGC 130 during speech activity 710, apply the noise gate during periods of noise activity, and resume the adaptation of the signal gain 732 at a level corresponding to the speech gain during the last speech activity 710. In the continuing example, the user at a receiving end of the voice communication link will hear a period of low-level silence or comfort noise between utterances of speech. Comfort noise can be inserted during the noise gate to prevent the user from thinking the call has been terminated. A user is likely to think that a call has been terminated or dropped if no audible sound is heard during periods of non-speech activity (e.g. silence). The controller 140 can apply the noise gate, or comfort noise, during levels of high background noise. In such regard, the user will hear synthesized background noise instead of garbled noise resulting from the suppressing of high background level noise.

Returning back to FIG. 4, as shown in method 443, the controller 140 can alternatively apply a smooth gain transition between a last speech frame gain and a gated noise frame during portions of noise in the gradient speech. The controller 140 can apply a linear, logarithmic, or quadratic decay but is not limited to these. For example, as shown in subplot E, the controller 140 can taper off (e.g. gradually decrease) the speech gain from a current speech gain during period of noisy activity to a noise floor level (e.g. noise gate) using a quadratic decay function. Notably, the controller 140 applies a smooth transition to lessen an abrupt change in level due to the transition of speech 710 to suppressed or gated level of noise 712. From the perspective of the user at the receiving end of the voice communication link, the background noise level heard during speech will smoothly transition to the noise floor level during periods of noise activity without any abruptions. The controller 140 suppresses a pumping effect (i.e. change in perceived noise level between periods of speech activity and noise activity) by gradually adjusting the signal gain level during periods of noise activity. In such regard, the controller 140 can suppress the noise in non-speech frames (e.g. noise activity) without introducing a perceived noise pumping that can occur as a result of applying a noise gate.

Upon reviewing the aforementioned embodiments, it would be evident to an artisan with ordinary skill in the art that said embodiments can be modified, reduced, or enhanced without departing from the scope and spirit of the claims described below. There are numerous configurations for achieving gradient processes with microphones or controlling an AGC that can be applied to the present disclosure without departing from the scope of the claims defined below. For example, the controller 130 can be integrated within the VAD 120 or the AGC 130 for controlling the signal gain during periods of noise activity. Moreover, the controller 130 can incorporate wind noise reductions means tied to the VAD 120 to improve wind noise reduction via a sliding filter or sub-band spectral suppression. The controller 140 can use the VAD to improve robustness of the intelligent noise reduction system. Furthermore, the controller 140 can prevent wind noise reduction from hampering voice recognition performance. These are but a few examples of modifications that can be applied to the present disclosure without departing from the scope of the claims stated below. Accordingly, the reader is directed to the claims section for a fuller understanding of the breadth and scope of the present disclosure.

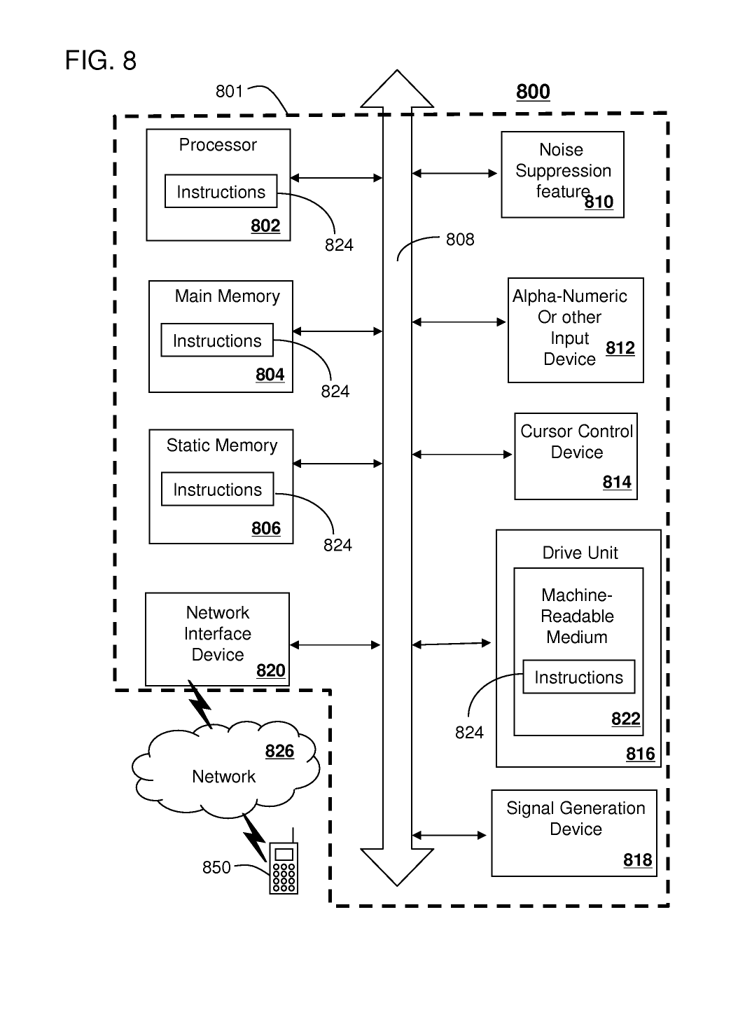

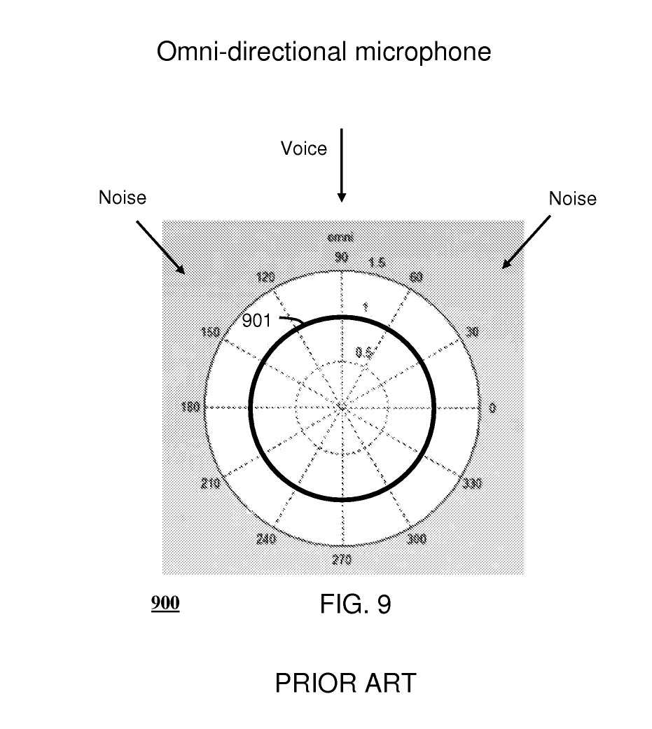

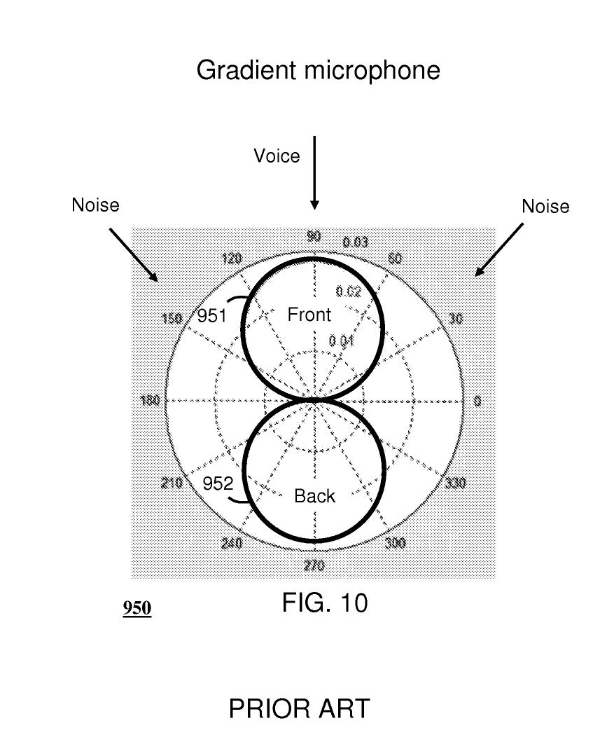

In another embodiment of the present invention as illustrated in the diagrammatic representation of FIG. 8, an electronic product such as a machine (e.g. a cellular phone, a laptop, a PDA, etc.) having a noise suppression system or feature 810 can include a processor 802 coupled to the feature 810. Generally, in various embodiments it can be thought of as a machine in the form of a computer system 800 within which a set of instructions, when executed, may cause the machine to perform any one or more of the methodologies discussed herein. In some embodiments, the machine operates as a standalone device. In some embodiments, the machine may be connected (e.g., using a wired or wireless network) to other machines. In a networked deployment, the machine may operate in the capacity of a server or a client user machine in server-client user network environment, or as a peer machine in a peer-to-peer (or distributed) network environment. For example, the computer system can include a recipient device 801 and a sending device 850 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication or presentations. Further, while a single machine is illustrated, the term “machine” shall also be taken to include any collection of machines that individually or jointly execute a set (or multiple sets) of instructions to perform any one or more of the methodologies discussed herein.

The computer system 800 can include a controller or processor 802 (e.g., a central processing unit (CPU), a graphics processing unit (GPU, or both), a main memory 804 and a static memory 806, which communicate with each other via a bus 808. The computer system 800 may further include a presentation device such as a display. The computer system 800 may include an input device 812 (e.g., a keyboard, microphone, etc.), a cursor control device 814 (e.g., a mouse), a disk drive unit 816, a signal generation device 818 (e.g., a speaker or remote control that can also serve as a presentation device) and a network interface device 820. Of course, in the embodiments disclosed, many of these items are optional.

The disk drive unit 816 may include a machine-readable medium 822 on which is stored one or more sets of instructions (e.g., software 824) embodying any one or more of the methodologies or functions described herein, including those methods illustrated above. The instructions 824 may also reside, completely or at least partially, within the main memory 804, the static memory 806, and/or within the processor or controller 802 during execution thereof by the computer system 800. The main memory 804 and the processor or controller 802 also may constitute machine-readable media.

Dedicated hardware implementations including, but not limited to, application specific integrated circuits, programmable logic arrays, FPGAs and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 824, or that which receives and executes instructions 824 from a propagated signal so that a device connected to a network environment 826 can send or receive voice, video or data, and to communicate over the network 826 using the instructions 824. The instructions 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications, permutations and variations as fall within the scope of the appended claims. While the preferred embodiments of the invention have been illustrated and described, it will be clear that the embodiments of the invention are not so limited. Numerous modifications, changes, variations, substitutions and equivalents will occur to those skilled in the art without departing from the spirit and scope of the present embodiments of the invention as defined by the appended claims.

What is claimed is:

1. An intelligent noise reduction system comprising:
a microphone unit to capture a speech signal;
a Voice Activity Detector (VAD) operatively coupled to the microphone unit to determine portions of speech activity and portions of noise activity in the speech signal;
an Automatic Gain Control (AGC) unit operatively coupled to the microphone unit for adapting a speech gain of the speech signal to minimize variations in speech signal levels; and
a controller operatively coupled to the VAD and the AGC to control the speech gain applied by the AGC to the speech signal.

2. The intelligent noise reduction of claim 1, wherein the controller prevents an update of the speech gain during portions of noise activity.

3. The intelligent noise reduction of claim 1, wherein the controller resumes adaptation of the speech gain following the portions of noise activity.

4. The intelligent noise reduction of claim 1, wherein the controller applies a noise gate during portions of noise activity.

5. The intelligent noise reduction of claim 1, wherein the controller applies a smooth gain transition between a last speech frame gain and a gated noise frame gain during portions of noise in the gradient speech

6. The intelligent noise reduction of claim 1, wherein the smooth gain transition is linear, logarithmic, or quadratic decay.

7. The intelligent noise reduction of claim 1, wherein the microphone unit is a gradient microphone that operates on a difference in sound pressure level between a front portion and back portion of the gradient microphone to produce a gradient speech signal, wherein a sensitivity of the gradient microphone changes as a function of a distance to a source producing the speech signal.

8. The intelligent noise reduction of claim 1, wherein the microphone unit comprises a first microphone, a second microphone, and a differencing unit that subtracts a first signal received by the first microphone from a second signal received by a second microphone to produce a gradient speech signal.

9. The intelligent noise reduction of claim 7, further comprising a correction filter that applies a high frequency attenuation to the gradient speech signal to compensate for high frequency gain of a gradient effect.

10. The intelligent noise reduction of claim 9, wherein the microphone unit comprises a first microphone, a second microphone, and a differencing unit to produce a gradient speech signal.

11. A method for intelligent noise reduction, the method comprising
capturing a speech signal;
identifying portions of speech activity and portions of noise activity in the speech signal;
adapting a speech gain of the speech signal to minimize variations in speech signal levels during portions of speech activity; and
controlling the speech gain in portions of noise activity to smooth audible transitions between speech activity and noise activity.

12. The method of claim 11, wherein the step of controlling the speech gain includes
preventing an adaptation of the speech gain during portions of noise activity.

13. The method of claim 11, wherein the step of controlling the speech gain includes
resuming adaptation of the speech gain following portions of noise activity.

14. The method of claim 11, wherein the step of controlling the speech gain includes
freezing the speech gain during portions of noise activity.

15. The method of claim 11, wherein the step of controlling the speech gain includes
applying a noise gate during portions of noise activity.

16. The method of claim 11, wherein the step of controlling the speech gain includes
applying a smooth gain transition between a last speech frame gain and a gated noise frame gain during portions of noise in the gradient speech,
wherein the smooth gain transition is linear, logarithmic, or quadratic decay.

17. The method of claim 11, comprising
capturing a first signal from a first microphone;
capturing a second signal from a second microphone;
subtracting the a first signal and the second signal to produce a gradient speech signal; and
applying a correction filter to compensate for frequency dependant amplitude loss due to the subtracting.

18. An intelligent noise reduction system comprising:
a gradient microphone to produce a gradient speech signal;
a correction unit to de-emphasize a high frequency gain of the gradient speech signal due to the gradient microphone;
a Voice Activity Detector (VAD) operatively coupled to the correction unit to determine portions of speech activity and portions of noise activity in the gradient speech signal;
an Automatic Gain Control (AGC) unit operatively coupled to the gradient microphone to adapt a speech gain of the gradient speech signal to minimize variations in speech signal levels; and
a controller operatively coupled to the VAD and the AGC to control the speech gain applied by the AGC to the portions of noise activity to preserve a speech to noise level ratio between speech activity and noise activity in the gradient speech signal.

19. The intelligent noise reduction system of claim 18, wherein the controller performs at least one among:
freezing the speech gain during portions of noise activity;
applying a noise gate during portions of noise activity; and
applying a smooth gain transition between a last speech frame gain and a gated noise frame during portions of noise in the gradient speech.

20. The intelligent noise reduction system of claim 18, wherein the controller prevents an adaptation of the speech gain during portions of noise activity, and resumes the adaptation of the speech gain following portions of noise activity.
